(19) United States
(12) Patent Application Publication
(10) Pub. No.: US 2003/0190394 A1
(43) Pub. Date: Oct. 9, 2003

(54) Apparatus for toasting sheets of laver

(76) Inventors: Makoto Suzuki, Neyagawa-shi (JP); Eiichi Suzuki, Osaka-shi (JP)

Correspondence Address: ECKERT SEAMANS CHERIN & MELLOTT, 600 GRANT STREET, 44TH FLOOR, PITTSBURGH, PA, 15219

(21) Appl. No.: 10/271,070

(22) Filed: Oct. 15, 2002

(30) Foreign Application Priority Data
Apr. 8, 2002 (JP) 2002-104660
Jul. 12, 2002 (JP) 2002-203396

(51) Int. Cl. A23C 3/00

(52) U.S. Cl. 426/523

(57) ABSTRACT

The wavy deflection of opposite side edges of sheets of laver is corrected to a flat form. A deflection correcting device 7 is disposed at a downstream position inside or outside a box 31 provided with a conveyor 5 and heaters 6, and is adapted to remove the wavy deflection from sheets of laver 91 while guiding the travel of the laver sheets. Each laver sheet 91 is toasted with the heat of the heaters 6 while the sheet is being moved inside the box 31 toward an outlet 33. The laver sheet 91 is soft when heated to a raised temperature. The laver sheet 91 in the soft state has its deflection removed by being pressed by the correcting device 7, and is corrected to a flat state, and made crisp when cooled by coming into contact with outside air.

### FIELD OF THE INVENTION

The present invention relates to an apparatus for toasting sheets of seaweed or laver, a production system incorporating the toasting apparatus and adapted to produce wrappers having laver enclosed therein, and a method of correcting the deflection of sheets of laver.

### BACKGROUND OF THE INVENTION AND PROBLEM TO BE SOLVED

Sheets of laver 91 having a nearly square, rectangular regular shape are produced by dipping a sheet making frame 95 into a material-containing liquid, withdrawing the frame from the liquid and drying the material as retained on the frame 95.

If the sheet of laver 91 is dried slowly, the laver is finished in a flat form.

In order to achieve an improved productivity, the present applicant attempted to dry wet sheets of laver with a hot air stream of high temperature, whereas a problem was then encountered in that the sheets of laver 91 are finished with opposite short side edges thereof deflected in a wavy form as seen in FIG. 12. Although the cause for the deflection of the laver sheets 91 still remains to be clarified, drying at a high temperature for a shortened period of time appears to produce more marked distortion along short sides of the sheet than along the long sides thereof.

Laver sheets 91 of regular shape are subjected to various aftertreatments including toasting, seasoning and cutting, while localized deflection of the sheets causes troubles to such aftertreatments as will be described below.

FIG. 11 shows a wrapper 96 having a sheet of laver enclosed therein and prepared by cutting a sheet of laver 91 into halves 92 so that the deflected side edges of the sheet will become longitudinal sides, sandwiching each half 92 obtained between films 44, 45 and thermally bonding the outer periphery of the resulting assembly. Such wrappers 96 are generally used for wrapping triangular rice balls and rolled sushi.

When sheets of laver 91 are flat and free from deflection, the laver sheets 91 can be transported smoothly in the wrapper production system shown in FIG. 1 and to be described later, but if the laver sheets 91 are deflected in a wavy form at opposite side edges thereof, the sheets will not be transported smoothly and are likely to cause trouble.

When bundles of wrappers 96 are placed into and stacked up in a stacker 22 shown in FIG. 13 of an automatic packaging machine for triangular rice balls or rolled sushi, the wrappers will not be stacked up straight but tend to make a somewhat inclined stack owing to the deflection of laver half sheets 92.

Accordingly, the wrappers 96 will not be delivered from the stacker 22 smoothly one by one but cause trouble.

Further even if the wrappers 96 can be delivered one by one, the bulkiness of wrappers due to the deflection of laver becomes an obstacle to the automatic packaging step, failing to produce neat packages or causing the packaging machine to malfunction.

With attention directed to the fact that sheets of laver are generally made into toasted sheets of laver by toasting like the laver sheets enclosed in wrappers, the present invention overcomes the foregoing problem by providing in a toasting apparatus a device for correcting the deflection of laver sheets by applying pressure thereto.

### SUMMARY OF THE INVENTION

The present invention provides an apparatus for toasting sheets of laver comprising a conveyor 5 and a heater 6 which are arranged in a box 31 having an inlet 32 and an outlet 33, the heater 6 being operable for toasting each of the sheets of laver while the laver sheet is being moved through the box 31 by the conveyor 5, the toasting apparatus being characterized in that a deflection correcting device 7 is disposed at a downstream position inside the box 31 or outside the box 31 for pressing the sheet of laver 91 to eliminate deflection from the laver sheet while guiding the travel of the laver sheet 91.

The invention also provides a system for producing wrappers having laver enclosed therein comprising as arranged downstream from an upstream position a bundled laver feeder 1, a laver delivery device 2, a laver toasting apparatus 3, a laver cutter 41 and a wrapping device 4 with use of films, as operatively connected to one another, the feeder 1 being operable to feed bundles 9 of sheets of laver one by one to the delivery device 2, the delivery device 2 being operable to deliver the sheets of laver 91 one by one from the lowermost position of the bundle 9 supplied to a stacker 21 to the toasting apparatus 3, the toasting apparatus comprising a conveyor 5 and a heater 6 which are provided inside a box 31 having an inlet 32 and an outlet 33 at opposite ends thereof for toasting each sheet of laver 91 while transporting the sheet on the conveyor 5, the cutter 41 being operable to cut the sheet of laver 91 into halves in a direction along deflected opposite side edges thereof, the wrapping device 4 being operable to pay off strips of films 44, 45 from film wound rollers 42, 43 arranged above and below a path of transfer of the cut half laver sheets 92, sandwich the half laver sheets 92 individually between the films, thermally bond the upper and lower films and cut the films into bags.

The invention further provides a method of correcting the deflection of sheets of laver by holding each of the sheets of laver in soft and hot state between rollers or belts from above and below at a downstream position inside or outside a box for toasting dry laver to eliminate the deflection, and cooling the laver to obtain a flat crisp sheet of laver.

Sheets of laver 91 which are deflected are placed into the box 31 through the inlet 32 and toasted with the heat of the heater 6 while being moved inside the box 31 toward the outlet 33 by the conveyor 5.

When heated to an elevated temperature, the sheet of laver is not crisp but is soft.

The laver sheet 91 in this hot and soft state is pressed from above and below by the deflection correcting device 7, therefore becomes flat with its deflection removed, and becomes crisp when cooled by coming into contact with outside air.

Since the heat of the heater 6 of the toasting apparatus 3 is utilized as it is for the correction of deflection, there is no need for any special heat source for correcting the deflection. This reduces both the initial cost and the running cost.

The deflection correcting device 7 is incorporated into the toasting apparatus 3 at a downstream position inside or outside the box 31 thereof. This obviates the need for a space for the installation of the device 7 and the time and labor for installing the device.

### BRIEF DESCRIPTION OF THE DRAWINGS

FIG. 1 is a diagram for illustrating a production system for wrappers having laver enclosed therein;

FIG. 2 is a diagram for illustrating an apparatus for toasting laver;

FIG. 3 is a perspective view of a roller conveyor and a deflection correcting device;

FIG. 4 is a view in section taken along the line A-A in FIG. 2;

FIG. 5 is a diagram for illustrating a second embodiment of deflection correcting device;

FIG. 6 is a diagram for illustrating a third embodiment of deflection correcting device;

FIG. 7 is a diagram for illustrating an embodiment of deflection correcting device which is disposed in proximity to the downstream end of a conveyor;

FIG. 8 is a diagram for illustrating an embodiment of deflection correcting device which is disposed between a downstream portion of a conveyor and an upstream portion thereof separated therefrom;

FIG. 9 is a perspective view of another embodiment of feed conveyor;

FIG. 10 is a perspective view showing an embodiment of deflection correcting device disposed outside a box of the toasting apparatus;

FIG. 11 is a diagram for illustrating a process comprising the step of making sheets of laver through the step of enclosing laver with films;

FIG. 12 is a perspective view of a sheet of laver having wavy deflected opposite side edges; and

FIG. 13 is a diagram for illustrating wrappers enclosing deflected laver and placed in a stacker.

### DESCRIPTION OF THE PREFERRED EMBODIMENTS

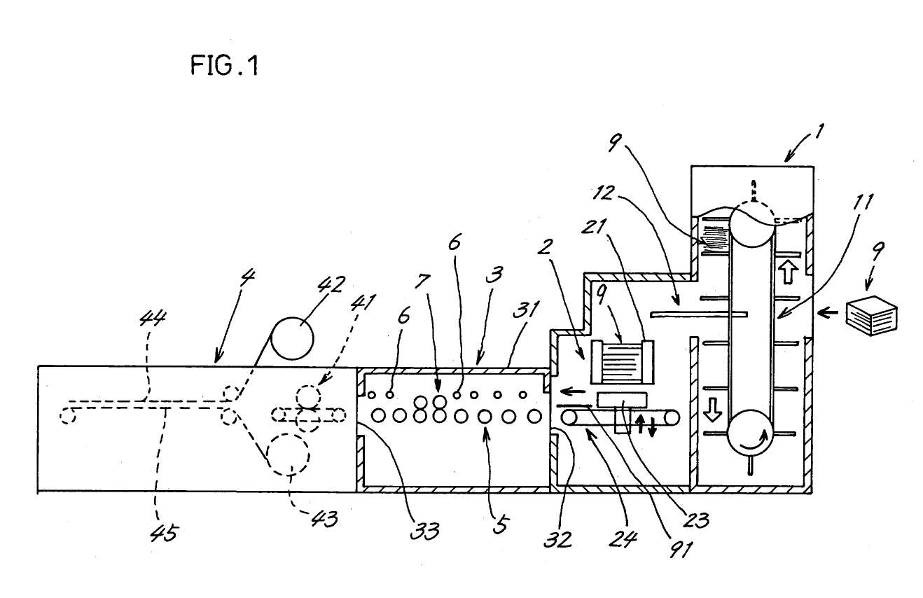

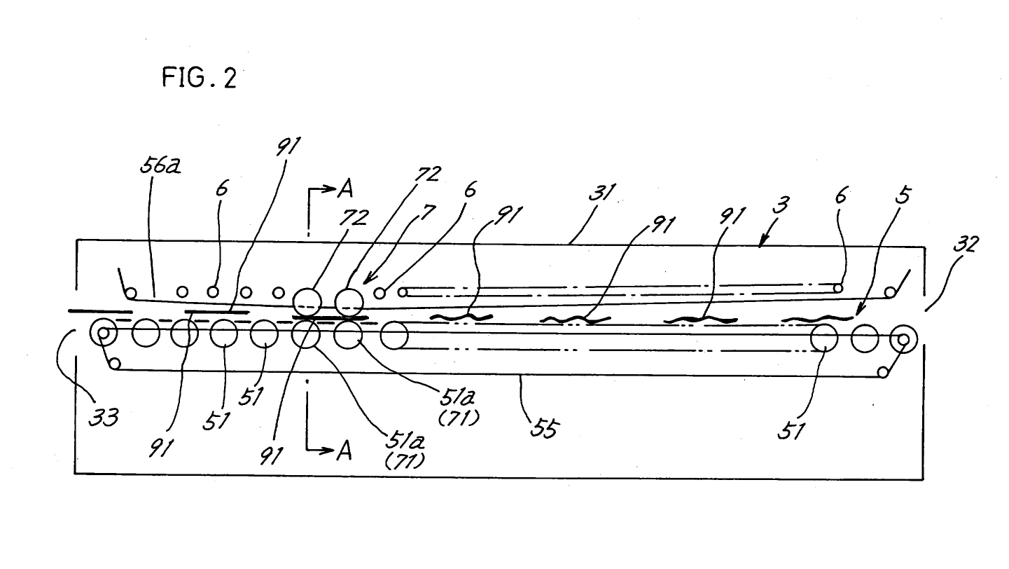

FIG. 1 shows a system for producing wrappers 96 for use with triangular rice balls or rolled sushi by toasting sheets of laver 91, cutting the sheets into halves and wrapping each of the halves with films.

The system for producing laver-enclosing wrappers comprises as arranged downstream from an upstream position (leftward from a position on the right side of the drawing) a bundled laver feeder 1, a laver delivery device 2, a laver toasting apparatus 3, a laver cutter 41 and a laver wrapping device 4 for use with films, these components being operatively related with one another.

The bundled laver feeder 1 comprises a conveyor 11 intermittently drivable along an endless path and a pusher 12 provided, for example, by a rodless cylinder, whereby bundles 9 of sheets of laver are fed one by one to the delivery device 2. Each bundle 9 comprises a specified number of laver sheets, e.g., 100 laver sheets.

In the delivery device 2, the bundled laver sheets 9 supplied to a stacker 21 are delivered by an upwardly or downwardly movable suction head 23 one by one from the lowermost position and fed by a feed conveyor 24 to the toasting apparatus 3 to be described later.

The feed conveyor 24 has a plurality of air slits 25 formed longitudinally thereof. Disposed between rollers of the feed conveyor 24 is a section device 27 for drawing air from the upper side of the conveyor 24. Air is drawn through the slits 25 in the conveyor 24 passing over the suction device 27 to prevent the laver on the feed conveyor 24 from being blown off.

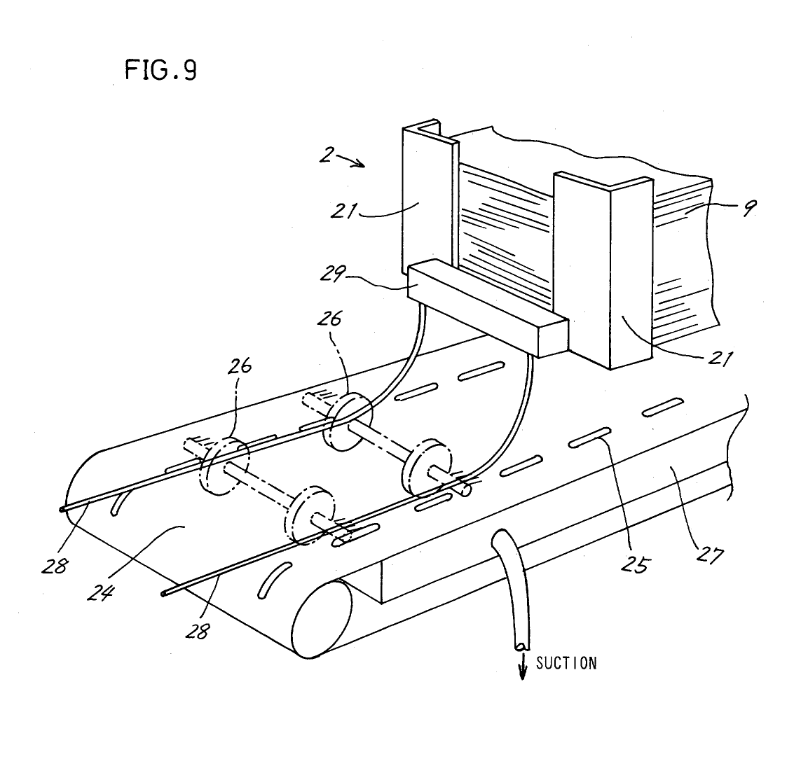

Holding members 28, 28 may be arranged on the feed conveyor 24 for preventing the laver placed on the conveyor 24 from shifting as seen in FIG. 9. In the illustrated embodiment, the holding members 28, 28 each comprise a flexible wire having one end attached to a support member 29 provided on the stacker 21.

The suction acting on the feed conveyor 24, the holding members 28, 28 and rollers 26, 26 arranged at fixed positions in contact with the conveyor 24 as described above eliminate the likelihood that the laver on the feed conveyor 24 will be blown off or will sift.

The toasting apparatus 3 is disposed at a position downstream from the feed conveyor 24, comprises a conveyor 5 and heaters 6 which are housed in a horizontally elongated box 31 having an inlet 32 and an outlet 33 at its opposite ends, and is adapted to toast sheets of laver 91 during transport on the conveyor 5.

The cutter 41 cuts sheets of laver 91 into halves centrally thereof along the deflected side edges. When required, the sheets of laver may be trimmed along the other end edges.

The wrapping device 4 pays off strips of films 44, 45 from film wound rollers 42, 43 arranged above and below the path of transfer of the cut half laver sheets 92, sandwiches the half sheets of laver 92 individually between the films, thermally bonds the upper and lower films and cuts the films into bags.

The present invention is characterized in that the laver toasting apparatus 3 is provided with a deflection correcting device 7.

The box 31 serving as a toasting oven of the apparatus 3 is horizontally elongated along the system for producing laver-enclosing wrappers, and has the inlet 32 in one end thereof adjacent to the delivery device 2 and the outlet 33 in the other end thereof adjacent to the cutter 41.

The conveyor 5 is provided inside the box 31 to extend from the inlet 32 toward the outlet 33. The heaters 6 are disposed above the conveyor 5.

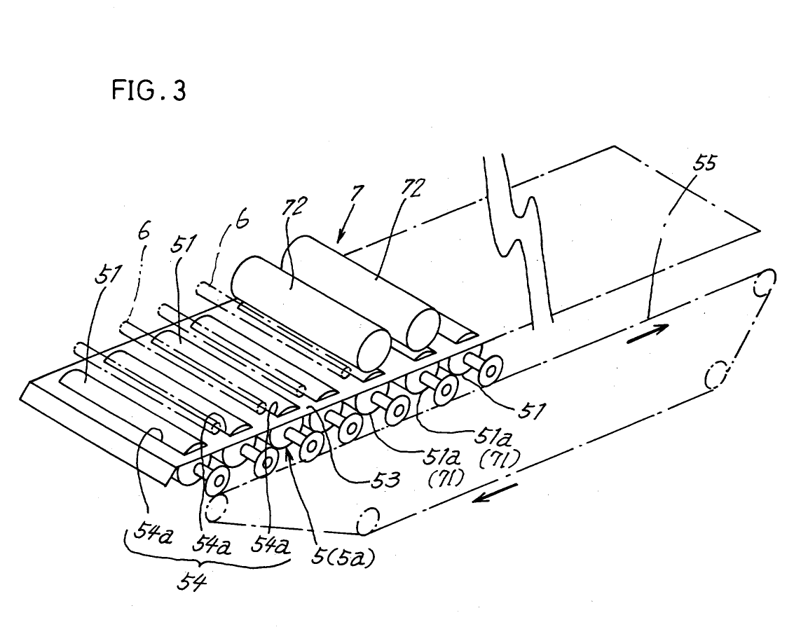

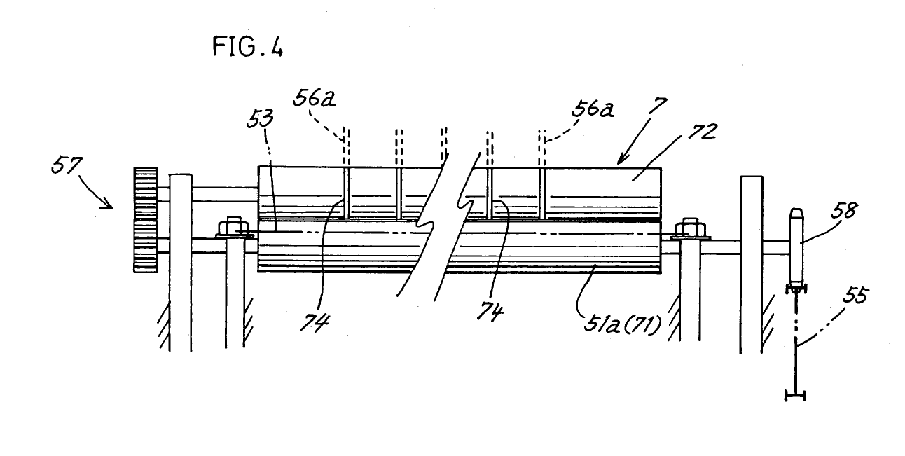

With reference to FIG. 3, the conveyor 5 is a roller conveyor 5a comprising a guide plate 53 elongated longitudinally of the box 31 and provided with a row 54 of slots orthogonal to the length of the plate, and a row of rollers 51 arranged below the guide plate 53 and having upper portions projecting upward from the respective slots 54a of the plate 53.

The rollers 51 are rotatingly driven by an endless drive chain 55.

Disposed above the conveyor 5 is a guide 56 for preventing sheets of laver 91 from jumping up on the conveyor.

The guide 56 of the embodiment comprises a plurality of guide wires 56a extending over the approximate entire length of the path of transfer of laver sheets 91 in proximity to the path.

The box 31 has hinged thereto a lid which opens the upper side of the box when opened. The lid is provided with a multiplicity of rod heaters 6 extending in parallel to the rollers of the roller conveyors and arranged in a row at approximately equal spacings along the conveyor.

When the lid is opened as turned upside down, the heaters provided on the rear side thereof are exposed. This assures the heaters of facilitated maintenance.

The pitch of the rod heaters 6 is 45 mm, and the heaters are about 25 mm away from the transport surface of the conveyor 5.

With the laver sheet toasting apparatus of the prior art, the rod heaters were arranged with a pitch of about 135 mm at a distance of 50 to 60 mm from the conveyor. In the case of the invention, the rod heaters are arranged with about ⅓ of the conventional pitch at up to ½ of the conventional distance from the conveyor 5. The heating means therefore has greater ability to toast laver sheets with radiant heat, serving to shorten the length of the toasting apparatus.

The device 7 for correcting the deflection of sheets of laver is disposed at a downstream portion of the roller conveyor 5a shown in FIG. 3. The deflection correcting device 7 comprises support rollers 71 and pressure rollers 72 for pressing the laver sheet from below and above while transporting the laver sheet. According to the illustrated embodiment, adjacent two rollers 51a, 51a in the row of rollers of the conveyor 5a are made to serve also as the support rollers 71, with two pressure rollers 72, 72 arranged on the respective support rollers 71, 71 in contact therewith.

The distance between the support rollers 71, 71, as well as between the pressure rollers 72, 72, is made smaller than the length of the laver sheet 91 in the direction of transport.

The pressure rollers 72, 72 are made of a metal such as stainless steel and supported at their opposite ends upwardly or downwardly movably to bear on the support rollers 71, 71 under gravity according to the embodiment.

The pressure rollers 72, 72 have circumferential grooves 74 for the respective guide wires 56a to fit in. These grooves 74 have a depth slightly greater than the diameter of the guide wires so that the guide wires 56a produce no clearance between the support roller 71 and the pressure roller 72 bearing thereon.

The pressure rollers 72 are coupled, each at one end thereof, to the support rollers 71 by gears 57, and the opposed rollers 71, 72 are rotated at the same peripheral speed in such directions as to guide the laver sheet 91 downstream.

When a bundle of laver sheets 9 is fed from the bundled laver feeder 1 to the laver delivery device 2, sheets of laver 91 are delivered one by one from the device 2 to the roller conveyor 5a of the toasting apparatus 3.

The sheets of laver 91 have their wavy deflected side edges positioned along the direction of transport.

The laver sheets 91 are transported downstream by the roller conveyor 5a and toasted with the radiant heat of the heaters 6.

When heated to an elevated temperature, the laver sheet 91 is not crisp but is softened.

When the soft laver sheet 91 is drawn in between the upper and lower rollers 72, 71 of the deflection correcting device 7 and moved along, the laver sheets 91 has its deflection corrected.

The upper and lower rollers 72, 71 of the deflection correcting device 7 are also heated by the high-temperature atmosphere within the box 31, and the laver sheet is flattened as if by being ironed over the upper and lower surfaces thereof.

The soft laver sheet 91 tends to rise by adhesion to the pressure roller 72 but is forced back toward the path of transport by the guide wires 56a fitting in the grooves 74 in the pressure rollers 72 and extending along the direction of transport of the laver sheet. This obviates the trouble that the sheet 91 will wind around the pressure roller 72.

The laver sheet 91 is given an enhanced flavor by toasting and becomes crisp when cooled by being brought out of the toasting apparatus 3 into contact with outside air.

Since the heat of the heaters 6 of the toasting apparatus is utilized as it is for correcting deflection, there is no need for a special heat source for correcting deflection. This reduces both the initial cost and the running cost.

The deflection correcting device 7 is incorporated into the toasting apparatus 3 and therefore requires no space for the provision of the device 7 or no time or labor for the installation of the device.

The laver sheet 91 is sent from the toasting apparatus 3 to the cutter 41, by which the sheet is cut into halves along the direction of transport.

The cut half laver sheets 92 are sent to the packaging device 4, strips of films 44, 45 are paid off from the film wound rolls 42, 43 arranged above and below the path of transfer of the sheets 92, the half laver sheets 92 are individually sandwiched between the films, and the films are then thermally bonded to form bags and cut into the bags, whereby laver-enclosing wrappers can be formed.

The wrapping device 4 is adapted to simultaneously wrap two half laver sheets 92, 92 as arranged in two rows.

Since the sheet of laver 91 delivered from the toasting apparatus 3 is in a flat state free of deflection, no trouble due to deflection occurs when the laver is cut and wrapped.

Further when wrappers 96 each comprising films having a half laver sheet 92 enclosed therewith are stacked up in a stacker of an automatic packaging apparatus for use in automatically packaging triangular rice balls or rolled sushi, the stack of wrappers is unlikely to incline unlike the stack of conventional wrappers comprising a half laver sheet enclosed therein as deflected, with the result that the wrappers can be delivered from the stack smoothly one by one.

The wrapper is flat and is therefore subsequently usable for preparing neat packages in an automatic packaging process free of trouble.

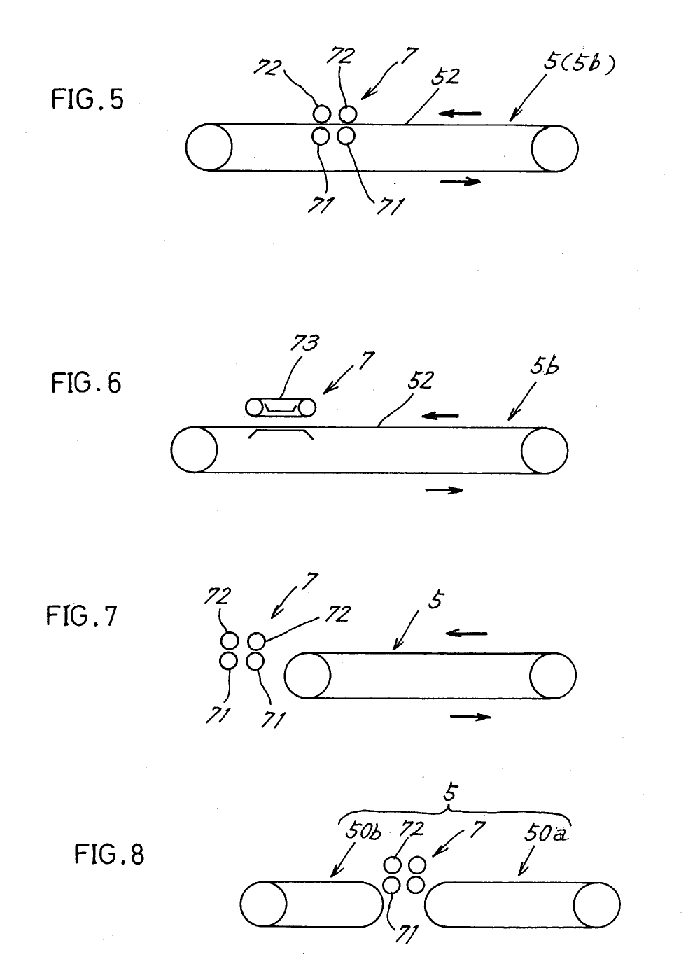

FIG. 5 shows a second embodiment of deflection correcting device 7 provided in the toasting apparatus. The conveyor 5 is a belt conveyor 5b. The conveyor 5b has an endless belt 52 made of netting of glass fiber.

The deflection correcting device 7 comprises support rollers 71, 71 provided under the advancing side of the belt 52 and pressure rollers 72, 72 arranged thereabove and opposed to the rollers 71, 71.

The support rollers 71 and pressure rollers 72 are rotatingly driven in a direction to advance laver sheets, as timed with the speed of transport of the belt conveyor 5b.

The support roller 71 and the pressure roller 72 may be provided in only one pair, but an arrangement of pairs of rollers produces an increased effect to correct deflection.

FIG. 6 shows a third embodiment of deflection correcting device 7.

The deflection correcting device 7 comprises an endless pressure belt 73 disposed above an advancing-side downstream portion of belt 52 of the belt conveyor 5b and to be pressed against the belt 52.

The pressure belt 73 is driven in a direction to advance laver sheets 91, as timed with speed of travel of the belt conveyor 5b.

FIG. 7 shows an embodiment of deflection correcting device 7 comprising support rollers 71 and pressure rollers 72 and disposed in proximity to the downstream end of the conveyor 5.

FIG. 8 shows an embodiment of deflection correcting device 7 disposed between an upstream portion 50a of a conveyor 5 and a downstream portion 50b thereof separated therefrom.

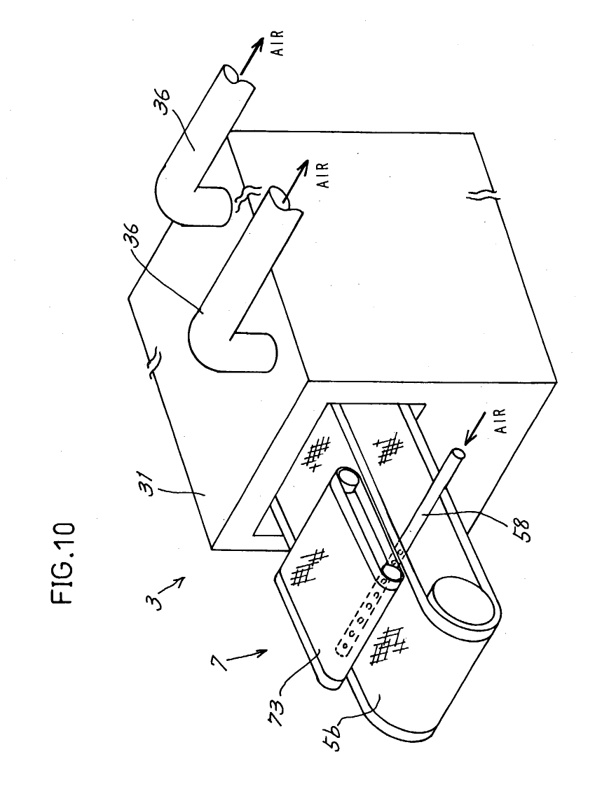

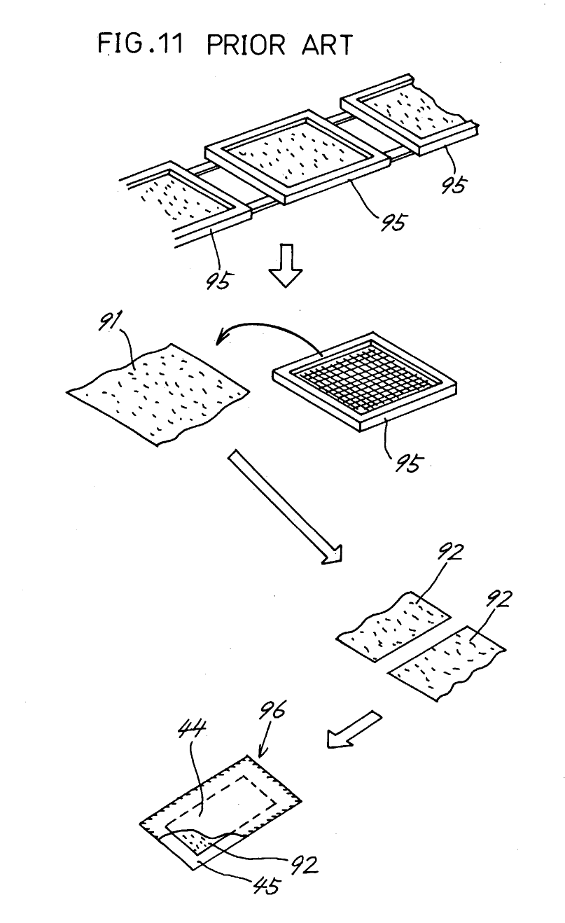

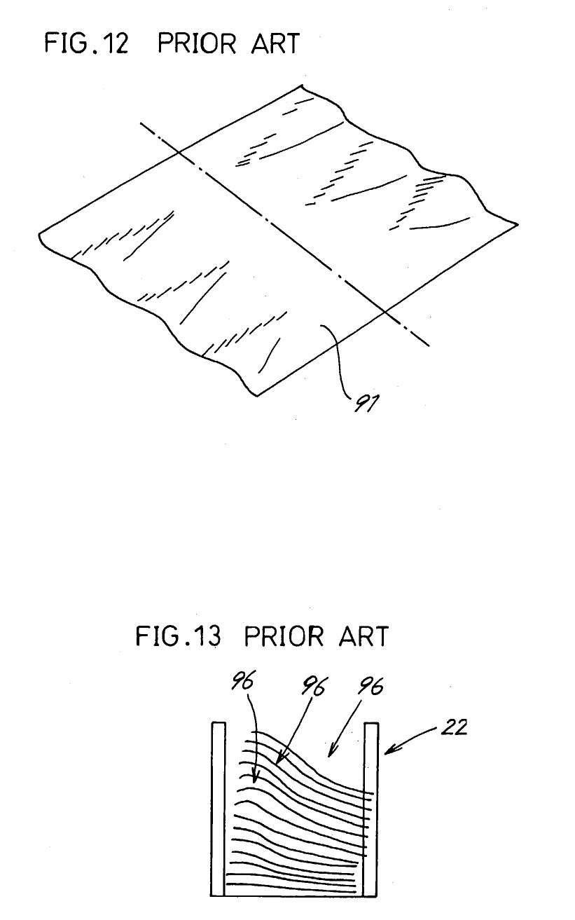

Although the deflection correcting device 7 is disposed inside the box 31 serving as the toasting oven of the toasting apparatus 3, the correcting device 7 may be provided outside the box 31 as shown in FIG. 10. FIG. 10 shows an embodiment comprising the deflection correcting device 7 shown in FIG. 6. The central portion of each of the belt conveyor 5b and the pressure belt 73 to be brought into contact with laver is preferably made from an air-permeable material such as netting. Preferably, an air discharge pipe 58 is disposed at the downstream end of the pressure belt 73 as shown in FIG. 10 for forcing out air against the belt conveyor 5b, whereby air is applied to the laver passing between the belt conveyor 5b and the pressure belt 73 and having the deflection eliminated to remove the heat and make the laver crisp. If the laver is packaged in a bag while hot, the laver will become moistened with water vapor to undergo a color change along the outer periphery of the sheet and degrade commercially, whereas when wrapped into a bag after removal of heat, the laver can be prevented from undergoing a color change.

Furthermore, the provision of the pressure belt 5b outside the box 31 which has a high temperature enables the belt 5b to have a prolonged life.

If the hot air inside the box 31 of the toasting apparatus 3 flows out of the box 31, the treated laver will be blow off or make the worker feel hot, so that it is desirable to provide exhaust ducts 36, 36 on the box 31 as shown in FIG. 10 for the removal of heat from inside the box 31.

The foregoing description of the embodiments is intended to illustrate the present invention and should not be construed as limiting the invention defined in the appended claims or reducing the scope thereof. The apparatus of the present invention is not limited to the above embodiments in construction but can of course be modified variously within the technical scope set forth in the claims.

What is claimed is:

1. An apparatus for toasting sheets of laver comprising a conveyor and a heater which are arranged in a box having an inlet and an outlet, the heater being operable for toasting each of the sheets of laver while the laver sheet is being moved through the box by the conveyor, the toasting apparatus being characterized in that a deflection correcting device is disposed at a downstream position inside the box or outside the box for pressing the sheet of laver from above and below to eliminate deflection from the laver sheet while causing the laver sheet to travel.

2. The apparatus for toasting sheets of laver according to claim 1 wherein the conveyor is a roller conveyor, and the deflection correcting device comprises support rollers provided by some of rollers of the roller conveyor and pressure rollers opposed to the respective support rollers.

3. The apparatus for toasting sheets of laver according to claim 1 wherein the conveyor is a belt conveyor, and support rollers and pressure rollers opposed to the rollers are arranged respectively on opposite sides of an advancing side of a belt of the conveyor to provide the deflection correcting device.

4. The apparatus for toasting sheets of laver according to claim 1 wherein the conveyor is a belt conveyor, and an endless pressure belt is disposed above an advancing side of a belt of the conveyor and movable along an endless path in pressing contact with the belt.

5. The apparatus for toasting sheets of laver according to claim 4 wherein the belt conveyor and the endless pressure belt each have a surface provided by an air-permeable material, and an air discharge pipe is disposed at a location where the air-permeable material of the belt conveyor is opposed to that of the pressure belt for forcing air against the traveling laver to remove heat from the laver.

6. The apparatus for toasting sheets of laver according to claim 1 wherein the deflection correcting device is disposed inside the box in proximity to a downstream end of the conveyor.

7. The apparatus for toasting sheets of laver according to claim 1 wherein the conveyor is divided into an upstream portion and a downstream portion on opposite sides of the deflection correcting device.

8. A system for producing wrappers having laver enclosed therein comprising as arranged downstream from an upstream position a bundled laver feeder, a laver delivery device, a laver toasting apparatus, a laver cutter and a wrapping device with use of films, as operatively connected to one another, the feeder being operable to feed bundles of sheets of laver one by one to the delivery device, the delivery device being operable to deliver the sheets of laver one by one from the lowermost position of the bundle supplied to a stacker to the toasting apparatus, the toasting apparatus comprising a conveyor and a heater which are provided inside a box having an inlet and an outlet at opposite ends thereof for toasting each sheet of laver while transporting the sheet on the conveyor, the cutter being operable to cut the sheet of laver into halves in a direction along deflected opposite side edges thereof, the wrapping device being operable to pay off strips of films from film wound rollers arranged above and below a path of transfer of the cut half laver sheets, sandwich the half laver sheets individually between the films, thermally bond the upper and lower films and cut the films into bags, the toasting apparatus being an apparatus according to claim 1.

9. A method of correcting the deflection of sheets of laver by toasting dry laver inside a box, thereafter holding the laver in the form of a soft and hot sheet between rollers or belts from above and below at a downstream position inside or outside the box to eliminate the deflection, and cooling the laver to obtain a flat crisp sheet of laver.
